(19) United States
(12) Patent Application Publication
(10) Pub. No.: US 2011/0142183 A1
(43) Pub. Date: Jun. 16, 2011

(54) Multiring apparatus and method to measure heat released by a sample loaded with hydrogen

(76) Inventor: Mitchell R. Swartz, Weston, MA (US)

(21) Appl. No.: 12/932,058

(22) Filed: Jul. 5, 2003

Related U.S. Application Data
(63) Continuation of application No. 08/406,457, filed on Mar. 20, 1995, now abandoned.

(51) Int. Cl. G21B 1/00; G21B 3/00

(52) U.S. Cl. 376/100; 976/DIG. 1

(57) ABSTRACT

The present invention relates to methods and systems used to examine the activity of a sample of a material involved in a reaction with an isotopic fuel. The system includes a novel holding apparatus for said sample of material with a surrounding structure means to examine and load said sample. Said apparatus also includes means to irradiate said sample of material during loading and means to assess the activity of said sample. In one configuration said means of examining the activity of said sample consists of a multiring calorimeter with a series of concentric chambers surrounding the centrally placed sample of material. Said means to examine said sample also includes means to detect changes in the volume of said sample during electrolysis or gas loading with said fuel, means to compare the activity of said sample of said material with other substances, means to semiquantitatively determine the activity of said sample of said material by determining the generated power and energy secondary to said loading, and comparing that to the input power and energy to obtain the ratios of the instantaneous power (P_{OUT}/P_{IN}) and the cumulative energy (Eₒᵤₜ/Eᵢₙ). Additional means include multiprocessor computation and second and third order corrections to the measured powers and energies using differential and integral temperature signals. Said means to examine said material also includes integration of accumulated data for determining the optimum electrical drive condition for said sample of material.

The present invention relates to methods and systems used to examine the activity of a material involved in the loading of, and reaction with, an isotopic fuel. Said material is from a group which includes palladium loaded with deuterium from heavy water or nickel reacting with ordinary water. The apparatus has relevance as well to systems utilizing pressure-loaded material. Said material also includes titanium and other members of Groups IV, V, some rare earths, and their alloys. By way of background and to place reasonable limits on the size of this disclosure, the following journal articles and papers may be used by way of background material and to supplement this specification.

### OTHER PUBLICATIONS

| Hansen, M. | Constitution of Binary Alloys, McGraw-Hill Book Co., |
|---|---|
| | Inc., 790-793, (1958). |
| Miles, M. M., | “Heat And Helium Production In Cold Fusion |
| B. F. Bush | Experiments”, Conf Proc., Vol. 33, Editor - Bressani, |
| | “The Science Of Cold Fusion”, 363--371 (1991). |
| Swartz, M. R. | “Quasi-One-Dimensional Model Of Electrochemical |
| | Loading Of Isotopic Fuel Into A Metal”, Fusion |
| | Technology, 296-300 (1992) |
| Swartz, M. R. | Swartz, 1997, “Consistency of the Biphasic Nature of |
| | Excess Enthalpy in Solid State Anomalous Phenomena |
| | with the Quasi-1-Dimensional Model of Isotope |
| | Loading into a Material”, Fusion Technology, 31, |
| | 63-74 (1997) |
| Swartz, M. R. | “Isotopic Fuel Loading Coupled To Reactions At |
| | An Electrode”, Fusion Technology, 26-4T, 74-77, |
| | (1994) |

Controlled nuclear fusion offers the possibility of inexpensive energy. A gallon of seawater contains one eighth of a gram of deuterium, separable at the cost of a few cents, and capable of generating, if burned in a controlled thermonuclear fusion reactor, the equivalent of hundreds of gallons of gasoline. However, deuteron-deuteron fusion—except in the solid state—remains exceedingly difficult because the electrostatic repulsion between the deuterons can be overcome in such kinetic systems only by approximately 0.1 MeV (at an equivalent temperature exceeding 100 million degrees Kelvin). In contrast, the reactions in the solid state involve an isotopic fuel loaded into a material (as deuterium loaded into a palladium cathode) or other materials (nickel cathode and ordinary water) to generate products such as heat and helium. Current sources are used to drive the desired reactions, and controlling the current source by feed-back rather than varying the electrical potential of the power source can minimize bubble formation which is of importance because it is inversely coupled to the loading [Swartz (April 1989)].

Extensive “positive” published results confirm the generation of products (including excess enthalpy) using isotopic fuel loaded into a material. Previously under the term “cold fusion”, these systems have expanded to include many types of materials and loading methods. Although these studies began fourteen years ago using heavy-water electrolysis with palladium cathodes and lithium salts, these methods now include light-water electrolysis with nickel cathodes and alkali-metal carbonate and other solutions, molten salt electrotysis with palladium as the anode, gas-plasma discharge devices incorporating palladium target cathodes, devices using a variety of proton conductors, hydrogen gas loaded into heated nickel reactors, and several acoustic techniques including collapsing bubbles vicinal to palladium metal into which the hydrogen is injected. Excess heat, tritium generation, and other products, produced by the desired reactions enabled by utilization of active samples of materials as detected by the invention described by the above-entitled application, have been found by scores of studies, in many countries, in deuterium-loaded solids, such as palladium and titanium. Ephemeral excess power peaks up to 1000% have been reported with short-term peak energy densities of 1-15 megajoules per cm³ of palladium. Light water solutions using nickel cathodes have been reported to produce excess heat during electrolysis (Swartz) in smaller amounts although there is a steady state component with a shorter time to onset.

The chief product of the cold fusion reaction(s) is excess heat. Helium, used to fill ordinary lighter-than-air balloons, is another product of cold fusion which is generated by, and linked to, the production of excess heat by palladium and heavy water. Near commensurate “ash” (that is, order-of-magnitude expected amounts or greater) consistent with a nuclear process was found linking the formation of helium-4 to the excess heat using metal flasks which were used to capture the helium-4 linked to the excess heat [Miles (1993)]. Other released particles have also been reported (including tritium, sparse neutrons, and possibly rare heavy elements).

There is thus compelling evidence that in the absence of another explanation as to the origin of these particles and enthalpic release, that nuclear reactions do occur in deuterium-loaded palladium and some other loaded and active materials. The growing number of scientific research papers in this field, their improved quality (both theoretical and experimental), and the increased number of publications solely devoted to this field, confirm both the “existence” and “utility” of these phenomena and the associated technologies.

Present calorimetry, used to examine the enthalpic behavior of present systems, is simple but the problems are formidable. These include the difficult determination of excess energy using the total heat produced and the input electrical energy. The procedures involve an electrolytic cell maintained either at an isothermal temperature, or coupled to a flow-calorimetric system, or in-situ as part of an adiabatic calorimeter. In some isothermal systems, the use of the heater and the presumed equation Pₓ+Pₕ=constant may allow the putative excess power, Pₓ, to be determined. If Pₓ increases, then the feedback control system of the calorimeter reduces Pₕ (or the flow in flow calorimetric systems) to maintain T_{c} constant. However, there are problems. Each of these techniques is fraught with problems of low signal to noise ratios, calibration and sensitivity, slow settling times and complications of use. Furthermore, there is no evidence that these reactions are even in the steady state. In summary, the experimental setup of cold fusion systems is so complex that the explanation of some previous “negative” experiments may reside in the calorimetric equipment, and the paradigms, as well as the material itself.

Most important, there are crucial material factors—loading and activity. In addition to inactive samples of material (detected and ruled out by the present invention), one reason for failure to achieve positive results usually resides with the insufficient loading of the active samples with the low atomic weight isotopes into said sample's metal lattice. The deuterons are exceptional within the palladium. Deuteron band states have been postulated to exist in the loaded material under some conditions in analogy with “electron” bands throughout the material (SN:07/339,976}, and that the upper “levels” (referring to the full saturation loading of the palladium with the isotopic fuel) have to be filled prior to fusion. Many “negative” results may be, in part, due to inadequate loading (Swartz SN:07/339,976), the failure to monitor said loading (Swartz SN:07/371,937**), or the failure to activate (Swartz SN:07/339,976, Swartz SN:07/371,937** and Swartz SN:07/760,970**). There has been insufficient (or no) mention of the amount of filling (loading) achieved in many previous “negative result” studies. The proper loading required must usually be in excess of the values mentioned (and more often not discussed) in the majority of the papers cited by the skeptics. As taught in SN:07/339,976, palladium must fill with, and thus physically absorb within it, enough deuterium to obtain the desired reactions. This only occurs when there are as many atoms of isotopic fuel (deuterons) as there are of the deuterium-free material, yet in almost the same, or slightly greater, volume. The increase in reproducibility of cold fusion has occurred only as matter of isotopic fuel loading has been applied.

Unfortunately, not all of the isotopic material of interest enters the metal. The loading flux into the bulk volume must be distinguished from the gas evolving flux. This is discussed in SN:07/339,976, Swartz, M., “Quasi-One-Dimensional Model Of Electrochemical Loading Of Isotopic Fuel Into A Metal”, Fusion Technology, 296-300 (1992), and Swartz, M., “Isotopic Fuel Loading Coupled To Reactions At An Electrode” (1993). These equations are complex because they include the differential isotope diffusivity, electrophoretic mobility, solubilities and the range of magnetic susceptibilities of the materials and products involved, and several parameters vary with temperature.

Furthermore, not all of the desired materials are active. The generally reported rates of cold fusion reactions are very low because of the variability of the—usually low—activity of the materials. Some inactive samples never fill. Others remain inactive even if composed of the correct composition because of variations in microcomposition, morphology, crystalline defects and other geometric, electrical, and material issues. Prior to fusion, samples of low activity must be filled with isotopic fuel to concentrations which require significant times of charging. These times may approach weeks or more, and borderline active materials may never ever fill. As the above-entitled application teaches, the activity is even a function of the driving input. Such discrete differences may not be detectable by conventional equipment because of the noise levels and prolonged inter-sequence time constants. In addition, palladium and some of the other preferred materials of these reactions are quite expensive. Also, the fusion reactions when successful can alter and damage the material, even leading to inactivity of the material. In summary, the inability to recognize and quantify the activity of the desired materials—and the slow initiation of excess heat in low activity samples—limits all successful research and development of this technology.

Accordingly, it is a principal object of the present invention to provide a novel method and system to examine a material for activity concerning the desired reactions. The invention as described in the above-entitled application addresses the issue of activity by enabling rapid examination of the activity of a sample of the desired material. Another object of the present invention is to evaluate and quantity the activity of said sample. Another object of the present invention is to provide a novel method to detect specific materials which demonstrate the activity required for potential bursts, or steady state levels, of these reactions. Another object of the present invention is to provide a novel method to detect materials which can fill, or otherwise react with, the isotopic fuel with shorter times until the onset of the desired reactions. Another object is to discriminate for optimal activity in a group of samples of said material. Another object of the present invention is to facilitate detection of long term changes in samples of materials by sequential studies. Another object of the present invention is to minimize the required quantity of expensive materials by successfully identifying higher activity materials. Another object is to determine a sample's optimal (“notch”) behavior. Another object is to categorize materials on basis of their optimal notch behavior. Another object is to improve filling abilities and efficiencies of equipment in the field by precharacterizing materials.

These and still further objects are addressed hereinafter. The foregoing objects are achieved in a system which includes in combination: a control subsystem, a sample from a group of materials able to be loaded either from an electrode electrochemical or gas loading subsystem, a novel holding apparatus for said sample with a surrounding structure comprising means to examine power and energy production from, and the size of, said sample of material, said apparatus employing a multi-ring calorimetric system, means to control temperature with dual feedback control loops, means to calibrate using ohmic and comparison materials, said multi-ring system containing a chamber contained within a series of nested concentric rings, said chamber containing means to enable the examination of said material, means for electrolysis or gas loading, means including a specialized table upon which the sample rests supported by a vertical vibrating rod means to derive the loading, means to drive excitation of said material, means to examine for changes in the size of said material under investigation, said means including means to apply a radiation field, means to determine size from said reflecting radiation field, means to monitor containing a moving barrier, means to include a pressure transducer, means to monitor the calorimetric properties of said material employing parallel paired platinum foil electrodes on each side of the material under examination means to enable electrolysis to continue with constant pathlength during the series of sequences, means to move said cathode into position by means of a hinge and elevated platform, means to connect the first and second ring through a gas permeable barrier, means to circulate liquid in the larger second ring, means to provide a source of in-situ magnetic fields for the inner ring, means to use a closed system containing a large area of the platinum as a recombiner, means to monitor pressure within the inner chamber, means to electrically couple said electrodes, means for a gas outlet tube for gas loading and sampling, means for feed-through assemblies in combination with sideport assemblies used to determine pressure within the inner and second ring, means to facilitate subassembly in-situ using prepared circuit boards and couplings, means for a third ring wherein there is a humidity detector, to determine catastrophe and correct for water pressure calculation, means for a fourth ring where there is coupling to thermal power source or sink such as a member of the group consisting of a Peltier heating/cooling device, or other thermal source, or heat pipe system, means to further isolate said apparatus, means including additional styrofoam or wooden thermal isolation supports in the outer and penultimate rings, heat removing apparatus, means to incorporate a microprocessor computation using differential and integral temperature signals, for determining the optimum electrical drive condition for said material, determining the activity of such material by determining the generated power and energy, and comparing that to the input to obtain the ratios of power (P_{OUT}/P_{IN}) and energy (Eₒᵤₜ/Eᵢₙ), and displaying the result in a thermal spectrogram.

This system described by the above-entitled application has many advantages over present systems. The following advantages are discussed without demeaning any of the others. The invention described by the above-entitled application avoids the need for correction for variable contributions of enthalpy to the gas stream. The electrical input is uniquely and easily defined because the thermoneutral potential is not used. Furthermore, the use of a small number in the denominator is avoided. Both power and energy are monitored so as to rule out energy storage and other false positives of “excess heat” [Swartz (1995)]. Corrections are made for nickel colloid generation, recombination, and sampling errors capable of generating false positives in other systems. Corrections are made for a full compartmental model of the rings including a corrected thermal mass of the inner ring and the thermal mass of the barrier now combined with the effective thermal admittance [Y₁₂] which now superimposes the radiative and conduction terms [Swartz (1995)]. The problems of real-time calorimetry are circumvented by the five ring calorimeter. The present invention includes two feedback points for controlling temperature in the outer (5th) and mid (either 3rd or 4th) rings. Differential calorimetry is used to examine heat transfer between rings as discussed in Swartz (1995). The enthalpic increases in each ring are calculated using a quasi-1-dimensional model of adiabatic calorimetry. By integration of the successive increases in volume and thermal mass of each ring (Table 1), there is increased stability and a short examination time constant. The present invention has increased stability with minimization of the background noise under controlled low to moderate current density conditions, enables a short examination time constant for multiple sequences, is able to examine many materials in detail with time constants of fractions of an hour to several hours, and has increased sensitivity because the time constant of the calorimeter and the mass of the examining volume. By determining a low thermal noise setting, this thermal spectroscopy may rule out false indications of “excess heat.” The multi-ring calorimetric portion enables the possibility of an accurate and precise characterization of a sample of a material, including whether said sample is capable of excess heat and under which conditions. The present invention enables devices using this technology to have decreased times of onset, and peak activity by determining notch behavior, and enables a decreased cost of systems by selecting active samples of materials characterized by optimal notch behavior.

The invention is hereafter described with reference to the accompanying drawings in which:

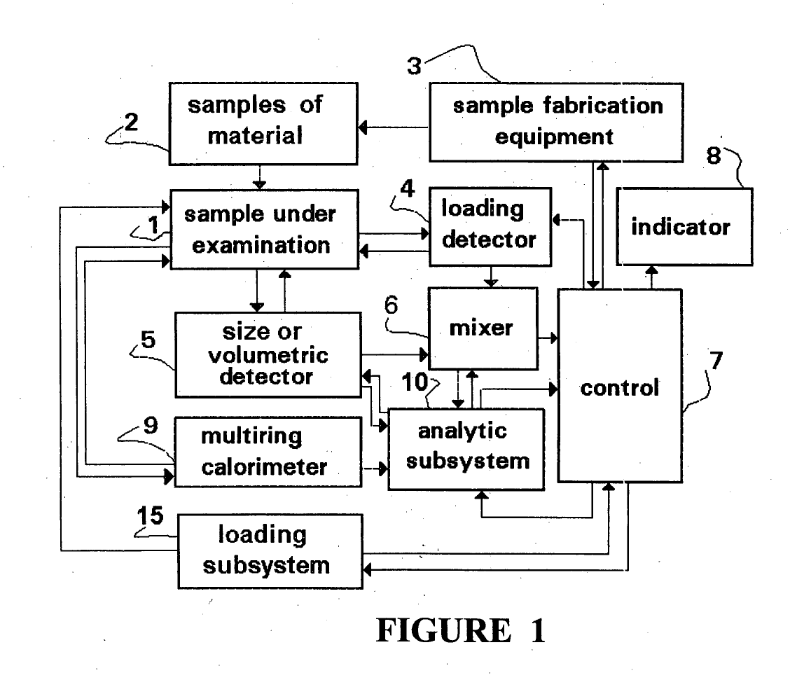

FIG. 1 symbolically shows the components used to interrogate a sample of a material into which an isotopic fuel is to be loaded. The sample is derived from a collection of samples obtained from sample fabrication equipment.

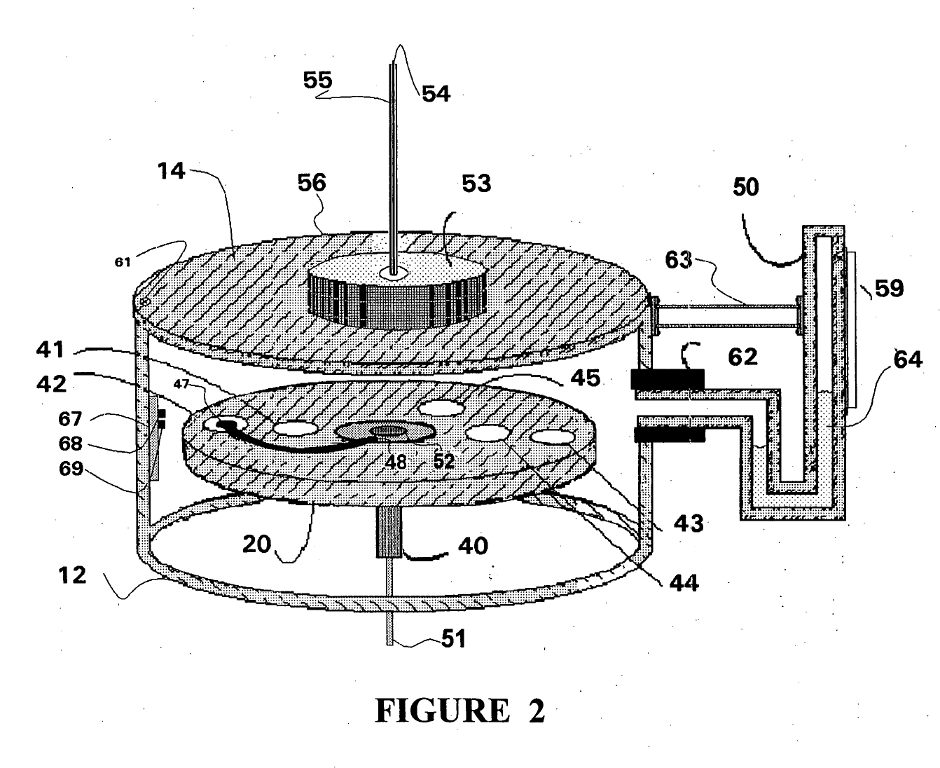

FIG. 2 is a simplified three-dimensional diagram which schematically shows the sample chamber for a sample of flat shape, and some of the electrical and acoustic monitoring equipment within the closed chamber apparatus. The sample is not shown for simplicity but lies fiat as a slab on the round table.

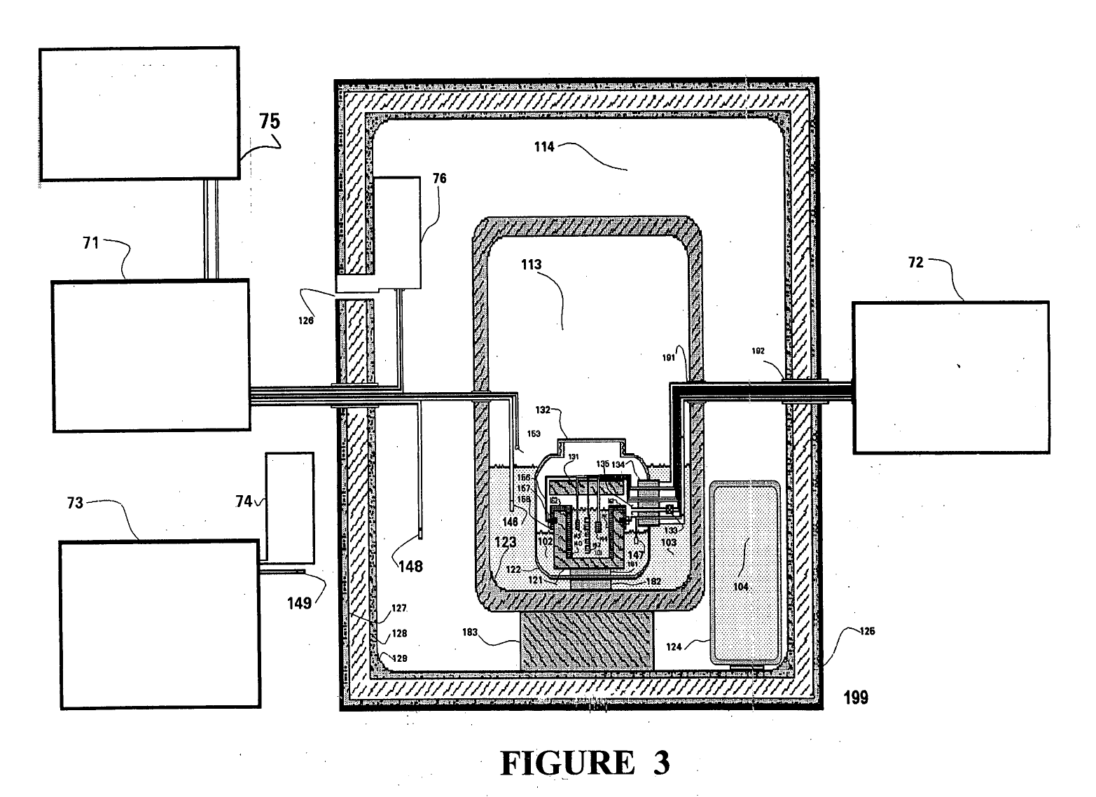

FIG. 3 is a simplified two-dimensional diagram of a five-ring calorimeter, one preferred embodiment of the present invention. The figure, and Table 1, present the rings and barriers as located from the source-ring (inner ring containing electrodes, ohmic control, thermistor) to the environment outside of the chamber (outer ring).

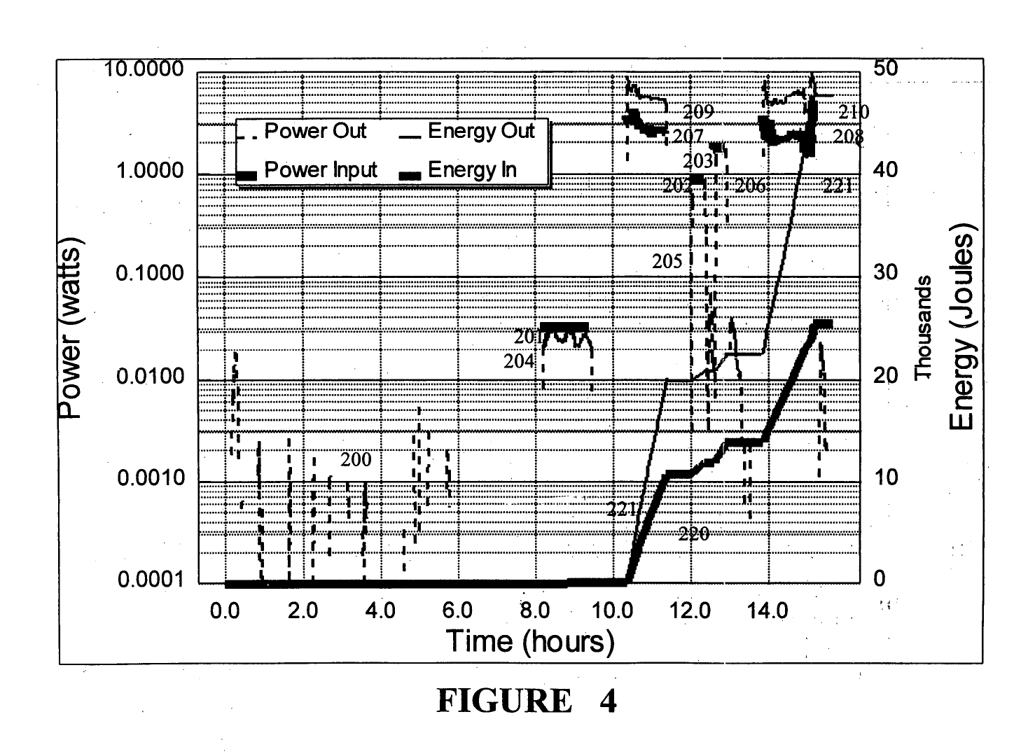

FIG. 4 is a graph showing the output of the apparatus in the form of a thermal spectrogram. This figure is for a reactor containing a platinum foil anode and a spiral nickel cathode [ordinary water (H₂O)]. The input and output power, and energies, of the calorimeter are shown. The step-like functions are the energy curves [read off the right y-axis]. The powers (thermal background, input, output) are the remainder of the curves and have a logarithmic scale (left y-axis).

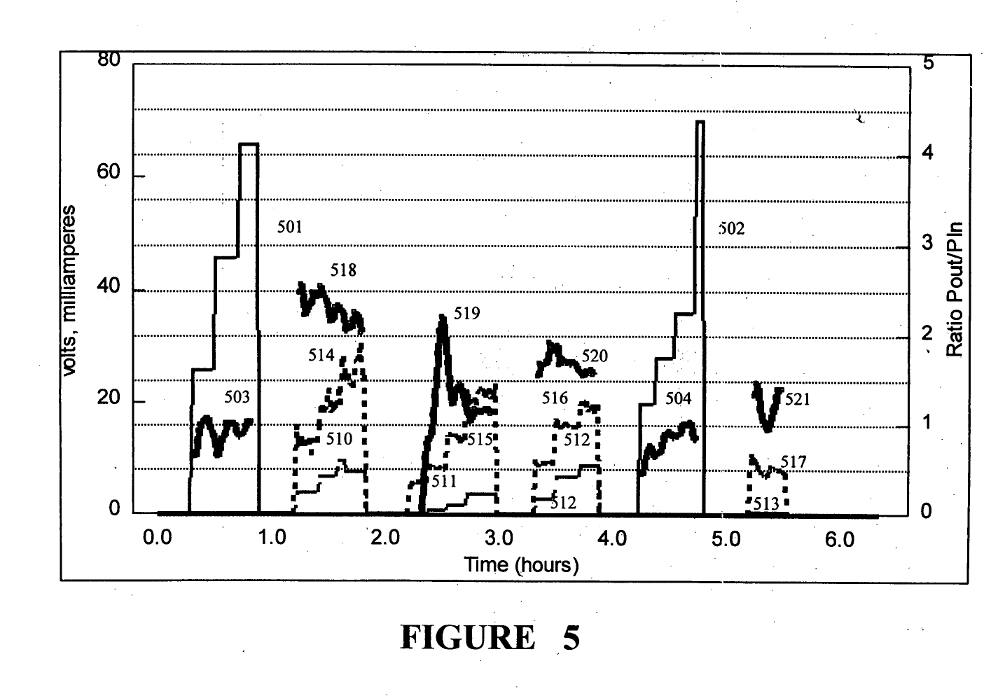

FIG. 5 is a graph showing the voltage and current (V-I) characteristics and power amplification for a reactor containing two platinum foil anodes and spiral nickel cathode [H₂O; Expt. 33-7] driven, in three configurations. The applied electrical variables (left axis) and the power amplification ratio (thick curves, right y-axis) are shown. The first and fifth pulses were delivered to the ohmic controls.

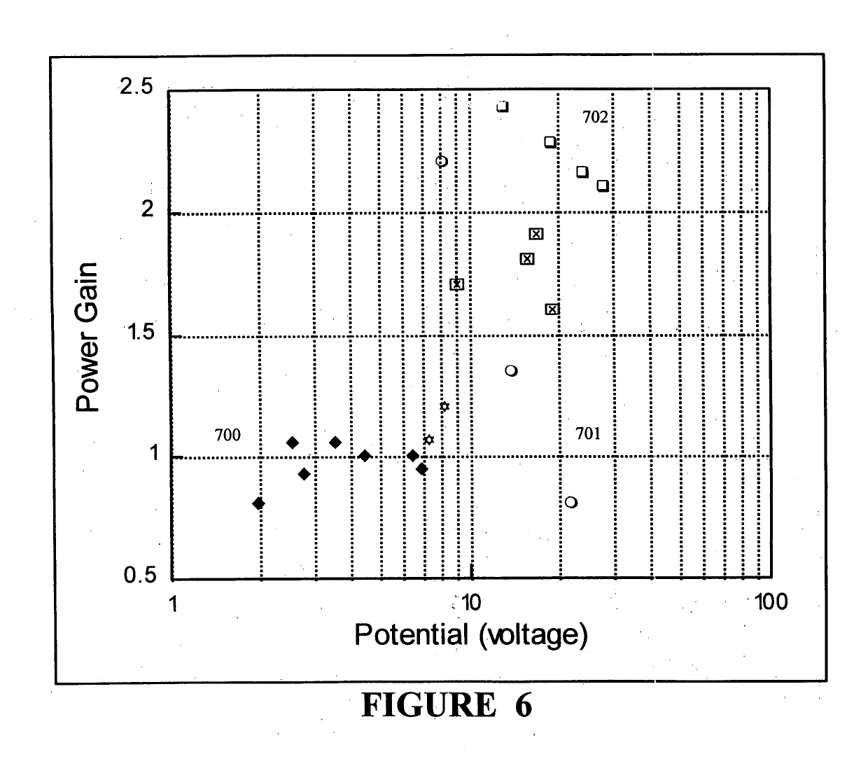

FIG. 6 is a graph showing the output of the apparatus containing a reactor with three configurations. The figure shows the power amplification for the platinum foil anode and spiral nickel cathode [H₂O; Expt. 33-7] as a function of the transsample potential. The points labeled as squares, filled squares, and open circles, refer to the platinum foil-spiral nickel cathode.

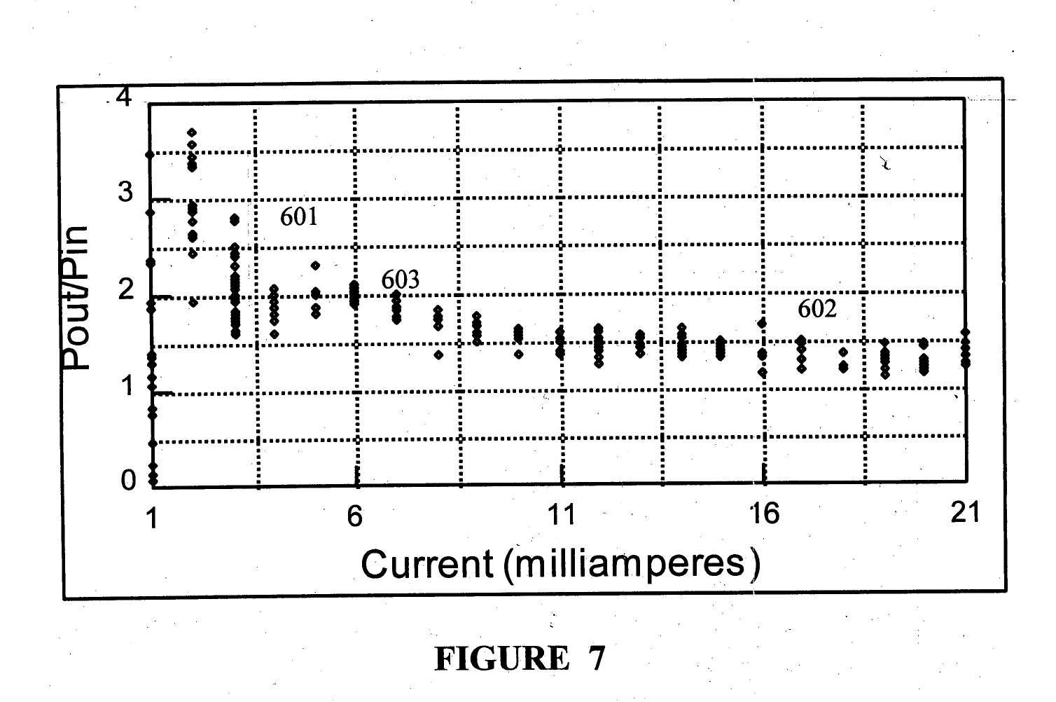

FIG. 7 is a graph showing the output of the multiring calorimetric apparatus. It demonstrates the biphasic character of the power amplification factor [π_{Ni} (nondimensional) defined as Pout/Pin] as a function of current in experiment 37-2.

In the following devices, palladium and nickel are the preferred embodiment for samples, but a larger group including Group IVb and Vb metals and some rare earths such as cerium, lanthanum, niobium, tantalum, thorium, vanadium, zirconium, and alloys and composites, may also be used.

Turning now to the figures: FIG. 1 symbolically shows the compartments used to interrogate a sample into which an isotopic fuel is to be loaded. FIG. 1 gives organization and shows that the sample under examination (label 1) is interrogated by two detection systems. These subsystems refer to the different parts of apparatus further discussed in this disclosure. The figure is not meant to be physically realistic with respect to size. The flow of control and information is shown by arrows. The sample (label 1) is taken from a collection of samples of a desired material (label 2) which are being processed by the sample fabrication subsystem which includes sample fabrication equipment (label 3). The sample is interrogated within the apparatus by transducers which include a loading detector (label 4) and a volumetric or size detector (label 5). The information passes through a mixer (label 6) to multiply the values and on to a control subsystem (label 7). The control subsystem controls the loading detection subsystem and the volumetric detection subsystem, and also provides user feedback through an indicator (label 8). The control subsystem can directly feed information back to the sample fabrication equipment (label 3). The sample is also examined for its enthalpic output in situ within the apparatus using a multiring calorimeter (label 9) and the associated analytic characterization subsystem (label 10). This information augments the other information received by the control subsystem (label 7). The control subsystem also controls the multiring calorimeter (label 9) and the analytic characterization subsystem (label 10), and the loading subsystem (label 15) which loads said sample.

There remains some confusion as to the definition of input power and excess heat. Input power in electrical and power engineering is defined as V*I. However, the electrochemistry considers, the thermodynamics by assuming the steady state is achieved. Although the standard free energy of water [[ΔG⁰₂₉₈(H₂O)=−237.18 kilojoules/mole] yields a theoretical decomposition voltage of water of 1.23 volts [Vₜₕᵣₑₛₕ=ΔG⁰₂₉₈(H₂O)/(2*F)], it is the thermoneutral potential (Vₜₕₑᵣₘ) which is subtracted from the cell voltage to derive the electrochemical “input power” where the voltage is V_{cell}−Vₜₕₑᵣₘ. The thermoneutral potential is based upon the standard free enthalpy of water [ΔF⁰₂₉₈(H₂O)], and is the potential which produces gas without a temperature change, and is 1.48 volts for light water and 1.54 for heavy water.

Although most calorimetry in the field is directed towards utilization of the thermoneutral potential it is not respected universally. The major reasons are the lack of thermodynamic equilibrium, the use of what is a sometimes very small number (V_{cell}−Vₜₕₑᵣₘ) in a denominator, and the lack of evidence that these reactions occur in an isothermal fashion. A proper way to use power and energy if issues of recombination are not known, and if equilibrium is not reached, is as follows. Input power is defined as V*I, and does not include reduction of the transsample potential by the thermoneutral potential (1.48 volts for light water). The output parameters (confer Table 2) derived from Pₒᵤₜ {the output power in watts} include the power amplification factor π_{Ni} (nondimensional) which is defined as Pₒᵤₜ/Pᵢₙ=π_{Ni} and the incremental excess power {=Pₓ; [watts]} which is defined and derived as Pₒᵤₜ−Pᵢₙ. It is also important to separate power from energy because energy storage and other mechanisms can create false positives of “excess heat” which are not supported by the complete energetic considerations.

FIG. 2 is a simplified three-dimensional diagram which isometrically shows the sample chamber used for flat samples. The closed chamber (labeled 12 with cover 14), interrogating electrodes for intrasample electrical conductivity measurement (labeled 41, 42, 43, and 44) and acoustic or optical transducers (labeled 53, 68 and 69) are shown. The latter determine the time of the sample by either a time-of-flight measurement, or by an interference pattern. An in-situ temperature probe (label 45) is shown. In the preferred embodiment for flat shaped sample, shown in FIG. 2, the sample would be placed upon the table (label 20), the cover (label 14) would be sealed with a series of mechanical screws (label 61, and of which only one is shown for simplicity). The label 52 represents one electrode upon which the sample is placed, and is made of platinum. The actual sample, palladium in the preferred embodiment, is not shown for simplicity. The label 40 is a rod supporting said table, and contains the metallic lead to the cathode, usually platinum, upon which the sample is placed, means to enable the cathodic portion of the electrical circuit. The label 51 represents the metallic lead to the cathode, usually platinum. The anode is arranged to have its surface parallel opposed to the upper flat surface of said sample, which is placed along, and over, electrical connectors 41 through 44 used for the in-situ conductivity measurement. The anode is hidden in the figure by the transducer (label 53) and is connected to the electrical anodic lead (label 54). All internal conductivity, and other, information is either electrically carried in conduits to the center of said rod (47, and the remainder not shown for simplicity) and there conducted (label 48), or telemetered (label 62), out of the chamber. For simplicity, the electrical connections, heat removing apparatus, and several other improvements described in this disclosure are not shown in FIG. 2.

The table (label 20), upon which the sample rests, is supported by the vertical vibrating rod (label 40): The equipment to covert that vibration to a mass-determination, and the apparatus to derive the loading from said mass is not shown, but has been described in Swartz (SN:07/371,937). After the sample (label 1) is placed upon the examination table, the chamber is then filled using a solution consisting in one embodiment of a LiOD and heavy water (D₂O) solution. The electrode assembly (label 55) is then lowered in position and adjusted, means to create a continuous and full electrical contact. The solution, power supply and control unit driving the loading have been described in Swartz (1989), and are not shown in FIG. 2 for simplicity. The sample is then electrochemically loaded. The application of the power source creates an applied electric field intensity which produces cation flow towards the cathode. There results in the near cathode solution a buildup of deuterons and a low dielectric constant (gas bubble) layer. A gauge (labeled 50) containing a solution (labeled 64) is used to determine any changes in the volume of the sample. In one configuration this is achieved through a side port and bracket assembly (labels 62 and 63) which are used to position the gauge (label 50) containing said solution (label 64). A leveling ruler, or pressure gauge, (label 59), the height of which is means to determine the pressure the cell. Additional supports (label 63) are provided to both mechanically brace and protect and support the gauge.

An electrode in a deuteron solution at equilibrium measures potentials associated with the Nernst equation, but has no information regarding the rate. However, during the fusion reaction, the system is not at equilibrium. Therefore, a quasi-1-dimensional model can, be used to describe the situation external to the cathode. In the absence of solution convection, molecular flux results from both concentration gradients and electrophoretic drift. In the material, concentrated solid solutions form. Solubility isotherms and x-ray results demonstrate at least two solid solutions of protons in palladium (Hansen). The deuterons reside in shallow energy traps located within, and throughout, the lattice. The deuteron-laden metal lattices change significantly with increasing deuteron loading—there is a progressive increase in the mass and volume of the sample of said material.

FIG. 3 shows a schematic diagram of the five-ring calorimetric system used to evaluate the sample. Swartz [SN:07/339,976 (Apr. 18, 1989)] taught the use of heat pipes, the means to capture the generated energy and flux obtained from the desired reactions with descriptions of a reactor support coupled to a heat capture unit. This device is significantly different in that there is more than one shell, and in that sequential semiquantitative information is collected through multiple sensing devices located within the multiple rings. FIG. 3, and Table 1, presents the successive concentric rings (labeled as 101,102, 103, and 104) and barriers (labeled as 121, 122, 123, 124, 125, and 132) as located from the inner [“source”] ring (label 101) to the environment outside of the chamber (label 199). For clarity, ring 4 (104) is shown as only a fraction of its actual size.

Table 1 lists the rings (each composed of several compartments and barriers) beginning with the inner (source) ring and ending at the environment outside of the chamber. The inner ring contains electrodes (labeled as 141 and 140 for the paired parallel anodes and 142 for the central spiral cathode), an ohmic control (label 143) and a thermistor (label 144). The electrochemical cell is completely contained in the first (inner) ring [labeled as 101 for the solution].

The second ring is a closed system containing a large area of the platinum as a recombiner (label 161 and 162) which, in the preferred configuration, is contiguous with the anodes (141,140), means to facilitate electrical connection (156, 157, 158 on the left side, and for clarity omitted on the other side). This second ring (label 102), the larger of the first two rings, also includes an in-situ pump motor. The barrier (label 121) between ring 1 and ring 2 is gas permeable. It is arranged so that the majority of the recombination would occur in ring 2, thereby eventually draining ring 1 of water over several days after each fill (depending upon the electrolysis rate, temperature, and pressure in ring 1). For many experiments, the barrier between ring 2 and ring 3 is completely sealed. Other materials in the inner two rings included polyethylene, polypropylene, methyl methacrylate, and Parafilm. Teflon tubing and tape [Chicago Specialty Mfg. Co., Teflon Thread Seal Tape (½″: #6241] are used for seals. A rubber stopper is used in the second ring, located above the water level. Neither silicates nor glasses are used.

In FIG. 3, the label 76 is the Peltier heating/cooling device requiring an opening (label 128) connecting the air in ring 4 (label 114) to the ambient (labeled 199). Other feed-through ports are shown (labeled 191, 192). For simplicity, not shown in either the figure, are the pump motor and the distal portion of the gas outlet tube (labeled as 133 and closed for all of the experiments of FIGS. 4 through 7) located in ring 2. The humidity detector in ring 3 or 4 is labeled 153. The acrylic, styrofoam, or wooden thermal isolation supports in rings 2, 3, and 4 are labeled 182 and 183. Some are not labeled. The inner two rings (labeled 101 and 102 in FIG. 3) are monitored for temperatures (+/−0.1 degrees K) using matched thermistors (labels 144 and 147). The thermistors (STH02) with their insulation of molded epoxy) had a rated accuracy of +/−0.8 degrees K over 223 to 383 degrees K, a precision of 0.1 degrees K (at 298 K), and a sensor time constant of 75 seconds in air, seconds in water. With 10 bit A/D conversion and storage, the calibrated precision of temperature measurement is <0.1K resolution [298K]/Rings 3, 4 and 5 are monitored for temperature (labels 146, 148, 149) using an Omega Engineering OMEGA 250 and Vaisala HMI32 temperature and humidity sensors (label 153). The outer ring in the calorimeter includes both Styrofoam (not shown) and an Igloo thermal box [label 125, and composed of multiple layers 27, 28, 29], supported by a wooden and an additional Styrofoam structure to minimize thermal conduction (not shown). Feedback control of temperature in either ring 3 or 4 is maintained by a Yellow Spring Thermal Controller Model 72 set at a bandwidth of 0.2 K. This is labeled 71, comprises the second control loop and is run by control unit (label 75). Feedback control of temperature in ring 5 is maintained by a Honeywell water circulation zone control heating (+/−2.5 degrees K). It is labeled 73 and includes an additional heater (label 74), which together comprise the first feedback temperature loop.

All nickel cathodes are handled, and cathode assemblies fashioned, using techniques so as to minimize organic and solvent contamination. For the spiral wire cathodes, Johnson Matthey brand wire [0.39 mm diameter] is carefully wound down upon a clean wood shaft of the desired diameter. This shaft is removed prior to the experiment. The iron cathodes were commercial grade [Mallinckrodt]. The anodes were constructed either from wire matched to the cathode, from short platinum wire stubs protruding through Teflon tubing or from a pair of thin platinum plates in an acrylic holder. The parallel paired platinum foil electrodes located on each side the of the spiral nickel cathode enabled electrolysis to continue with constant pathlength during the experiment. This is 0.95 cm to the center of the spiral at in the midline at axis. Ohmic resistors are carefully prepared with multiple layers of Cole-flex irradiated polyolefin heat shrink tubing (ST221) to minimize their contact with the solution. They are thoroughly washed and air dried, as are all electrodes, prior to use. All electrodes in the five ring calorimeter with the closed inner two rings are necessarily prepared and assembled in-situ in ring 2 using prepared circuit boards to enable the construction and successful termination of leads. These connectors can minimize the product of specific heat and mass, avoid excess humidity (and thus light water) removal by the cabling, and enable easy electrical connection within the reactor.

The experiments for FIGS. 4, 5, 6 and 7 were conducted without additional illumination. Voltages (+/−0.5%) are measured with a Keithley 610C Electrometer, Keithley 179 TRMS digital multimeter, or HP 412 vacuum tube voltmeter for the reactor. An Amprobe-4B, Amprobe 9, or Triplet 3550 multimeter are used for the other electrical ports. All AC measurements are made with Tektronix 7403N oscilloscope, Princeton Applied Research Model 121 Lock-in Amplifier, and Microdot F280A programmable waveform generator. Current sources included a Keithley 225 and JET Technology 1280 and 1200 Electrophotodynamic Drivers™), with transsample potentials of peaks voltages of 107 volts, 20, and 15 volts respectively (label 72). Electrical currents (+/−1%) ranged from 1 nanoampere to 0.4 amperes. Electrical voltage sources used for the high-power ohmic testing included LAMBDA 340A and HP722 AR. The power source used for the pump motor in the second ring is a Heathkit regulated power supply 1P-1B. The pump, in ring 2, also a source of in-situ magnetic fields for ring 1, delivered ˜49 milliwatts heat when in use. In the absence of pump use, there is negligible EMI interference (to 1 Megahertz) of any significance relative to the excess power levels reported here. With the electrical cables in parallel, and with solution impedances in the range of 400 to 19,000 ohms, even less EMI-contributed power would be available than in these control experiments where no effort was made to minimize the area subtended by the leads. In such control experiments, peak induced voltages are less than 50 millivolts which would imply peak available power levels (if the EMI is able to couple to the electrode-cable system and is then impedance matched to the radiation resistance of the nickel-electrolyte-platinum system) of 10 microwatts. This power level is two orders of magnitude below the lowest noise levels here, and is of no significance. Impedances of all components [including the open electrolytic cells when dry, and leads to the electrochemical cell (range 0.4 to 1.8 ohms)] are measured and used to derive corrected values of V_{cell} from V_{applied}.

Because many of the papers in the literature used internal ohmic heaters of only 10 to 100 ohms and because of the criticism ohmic resistors from 100 to 10,000 ohms were used as well as the inclusion of the lead resistances in all calculations. The use of platinum foil enabled large area anodes (2.5 cm² peak). The electrochemical cell constant (L/A [1/cm]) is 0.76. The loading is with ordinary water (Na 11b milliequivalents per liter, K 0.01 milliequivalents per liter, CO₂—, pH 7.4) The electrical resistivity of the aqueous solution is 1667 ohm-cm.

To circumvent sampling error, in all cases of computed data acquisition, samples are taken at rates of 1 Hertz or greater. Parallel monitoring of data enabled cross-checking of equipment as well as real-time imaging of variables (T₁, T₂, input power), and computer storage [Amiga 4000, U.S. LOGIC P-60]. A voltage divider coupled the Keithley 610C output to the computer input port for data storage. The computed input is taken with a 68000 microprocessor (Commodore Amiga 2000) with a sampling rate of 1-100 Hertz, with storage on BERNOULLI Multidisk (2-5 megabytes per channel-day). Data acquisition used an ezAD™ measureport 105 A/D converter (Boone Technologies, Inc., VA) with modules for three differential inputs, a DATEL 112 unit, and a JET Technology 1280. All data samples are averaged over one minute to improve resolution, stability, and because the PC portion of the computer system overloaded with matrices of size beyond 100×4000. Therefore, each experiment was preprocessed to vector form (minute, T₁, T₂, T₃, T₄, voltage, current) using time-averaging 68040-coprocessor software which decreased the data size thereby enabling PC final processing. Storage and preprocessing with the 68040 and then final compilation with the PC-Pentium significantly improved performance.

The mathematical solution to the power and energy flow equations are derived from a quasi-one dimensional [“Q1D”] model which should not be confused with the Q1D model of isotope loading [Swartz (1992), Swartz (1993), Swartz (1994)]: Account in the calculations is taken of the specific heat and mass of all barriers. Given that there are no sudden changes in thermal diffusion, and ignoring the inhomogeneities and anisotropics, the barriers 1, 2, 3, and 4 remain spatially fixed, thereby making the mathematical solution amenable to a quasi-one dimensional analysis which has been discussed elsewhere in detail [Swartz (1995)]. The boundary conditions are the first ring (containing the electrochemical cuvette and monitored as T₁), the feedback-controlled midrings (T₃ or T₄), and the zone-controlled room temperature. The heat and mass transfer equations between each set of rings determines the excess heater power (both as an incremental term and amplification rate) and excess energy, if any.

What is usually done is to use Newton's method and assume a linear time-invariant system. The output power is determined from the temperature rise, that is T₁−T_{bath}(=0). However, the best calorimetric analyses [Fleischmann (1993)] include at least additional terms involving thermal transfer by radiation.

$${C}_{P , {H}_{2} O , l} {M}^{0} * \frac{d Δθ}{d t} = [ {V}_{cell} ( t ) - {V}_{thermoneutral , bath} ] * I - \frac{3 I}{4 F} * \frac{P}{{P}_{ambiens} - P} * [ ( {C}_{P , {H}_{2} O , g} - {C}_{P , {H}_{2} O , l} ) * Δθ + {L}_{{H}_{2} O} ] + {P}_{x} ( t ) + \{ {P}_{h} * [ {u}_{- 1} ( t ) - {u}_{- 1} ( t - τ ) ] \} - {k}_{R} * [ {( {θ}_{bath} + Δθ )}^{4} - {θ}_{bath}^{4} ] \qquad [ Eq . 1 ]$$

The left hand term in this differential equation of thermal transfer is the increase in enthalpy within the calorimeter. They terms on the right hand side are the enthalpic input from the electrolysis, the component of enthalpic content leaving with the electrolysis gas stream, the putative excess power (if any), the heater calibration pulse (with the Heaviside functions), and the radiative transfer to the water bath. There are some major problems, however, with this equation. First, in contrast to the single left hand term, the lumped parametric increase in enthalpy within the calorimeter is actually composed of several terms. Most important, some of these terms are not even a function of Δθ (see below)! Three other problems with the equation include the use of the thermoneutral potential from the bath rather than the cell, the admitted lack of thermal conduction term, and the non-specificity with respect to the signal temperature (θ; here T₁, T₂, T₃, T₄, and T₅). As discussed below, many of these issues are corrected by the teachings of the above entitled application. In this more advanced model, thermal conduction is included. The other errors corrected here include the integrated compartmental model of the rings which enables consideration of enthalpic uptake by each successive barrier. Also the terms comprising the non-aqueous portions of the calorimeter are explicitly separated out as the components (reflected as the summation term below) in each compartment. Some of the materials constitute barriers between rings and hence the energy terms have T₁+T₂ terms as opposed to only T₁−T₂ terms. Thus, Δθ is not used here simply because it is equal to T₁−T₂ but more importantly because there is additional data which can be derived by the use of the additional rings.

Because successive rings are involved and used, this additional information [enthalpy to ring 2 (previously “bath”)] is not lost, but can be added in for each level. This analysis also enables inclusion, of those terms in the heat and mass transfer equations which are not a function of the differential temperature (Δθ).

$$[ {C}_{P , {H}_{2} O , l} * {M}^{0} + {\sum }_{i} ( {C}_{P , i} * {M}^{i} ) ] * \frac{d {T}_{1}}{d t} + ( \frac{[ {C}_{P}^{{Z}_{12}} * {M}^{{Z}_{12}} ]}{2} ) * \frac{d [ {T}_{1} + {T}_{2} ]}{d t} = [ {V}_{cell} ( t ) - {V}_{thermoneutral} ] * I - \frac{3 I}{4 F} * \frac{P}{{P}_{ambiens} - P} * \{ [ ( {C}_{P , {H}_{2} O , g} - {C}_{P , {H}_{2} O , l} ) * ( {T}_{1} - {T}_{2} ) ] + {L}_{{H}_{2} O} \} + {P}_{x} ( t ) + \{ {P}_{h} * [ ( {u}_{- 1} ( t ) ) - ( {u}_{- 1} ( t - τ ) ) ] \} - {k}_{{R}_{12}} * [ {T}_{1}^{4} - {T}_{2}^{4} ] - {k}_{{c}_{12}} * [ ( {T}_{1} - {T}_{2} ) ] \qquad [ Eq . 2 ]$$

As discussed in Swartz (1995), this equation can be simplified somewhat by the definition of α₁ which implicitly contains the integrated i+1 terms comprising the thermal capacity of ring 1 (electrolyte, electrodes and leads, thermal sensor and leads, and ohmic controls and leads), and by γ₁₂ which represents the thermal capacity of the first barrier, calculated to first order as the product of the specific heat (C_{Z12}) and mass (M_{Z12}) of the barrier between the first and second rings. By the use of the zeroth and first order terms of the source heat; the binomial expansion, the definition of an effective thermal admittance is made [Y₁₂] which includes radiative and conductive components of the barrier between rings 1 and 2 [Swartz (1995)].

Y₁₂=k_{C}+(4*k_{R}*[T₂]³) [Eq. 3]

For this approximation under low power conditions, it is assumed that the contribution of enthalpy to the gas stream is minor and can be ignored for several reasons. These reasons are that the term is second order, that the Faraday is used in the denominator (adding a factor of 10⁻⁵), that the currents are low in these experiments (below 0.4 amperes) and finally and most importantly that the input power here is defined as V*I. In this system (closed within rings 1 and 2) the electrical input is uniquely and easily defined because the thermoneutral potential is not used.

Thus, in the quasi-1-dimensional model of multi-ring calorimetry, the corrected thermal mass of the inner ring and the previously neglected thermal mass of the barrier are now combined with the effective thermal admittance [Y₁₂] which now superimposes the radiative term with the previously neglected conduction term to derive a better approximation. P_{source} is divided into its components. For this analysis, the source (or incremental excess heat) Pₓ is replaced by an ohmic component (as one control), and by the electrolysis, in combination with any putative excess heat. Furthermore, for these experiments the resistive leads to the electrochemical cell are premeasured and where possible arranged to be low in their electrical impedance relative to the electrical impedances within the cell. Kirchoff's law corrects for the lead impedance\

V_{cell}=V_{applied}−[I*(R_{leads}+R_{contacts})] [Eq. 4]

Thus,

$$[ {V}_{applied} - [ I * ( {R}_{leads} + {R}_{contacts} ) ] ] * I + {P}_{heater} ( t ) + {P}_{electrolysis} ( t ) + {P}_{excess} ( t ) ≅ \frac{\begin{matrix}[ 4.184 * {α}_{1} * Δ {T}_{1} ] + [ 4.184 * {γ}_{12} * ( Δ {T}_{1} + Δ {T}_{2} ) / 2 ] + \\ [ {Y}_{12} * ( {T}_{1} - {T}_{2} ) * Δ t ]\end{matrix}}{Δ t} \qquad [ Eq . 5 ]$$

These calculations are repeated for each ring with consideration of the different barriers and volumes. Each ring is treated as having a “source” consisting of the inner rings. Each ring and component within (with each of the barriers comprising a compartment too) is considered. Each ring is treated as having a “source” consisting of the inner rings. Calculations using each successive ring can verify the measurements of each inner ring by adding in those energies shifting to the next ring. The final rings (3 or 4 and rarely 5) can be linked in the customary fashion to the power supplied to the heater. Thus in more general sense, for any subsequent ring j, there follows paired coupled equations.

$$\begin{matrix}[ {V}_{applied} - [ I * ( {R}_{leads} + {R}_{contacts} ) ] ] * I + {P}_{x} ( t ) + {P}_{h} ( t ) = \frac{\begin{matrix}[ 4.184 * {α}_{j} * Δ {T}_{j} ] + [ 4.184 * {γ}_{jj + 1} * ( Δ {T}_{j} + Δ {T}_{j + 1} ) ] + \\ [ {Y}_{jj + 1} * ( {T}_{j} - {T}_{jj + 1} ) * Δ t ]\end{matrix}}{Δ t} & [ Eq . 6 ] \\ {Y}_{j , j + 1} = {k}_{{C}_{j , j + 1}} + ( 4 * {k}_{{R}_{j , j + 1}} * {[ {T}_{j + 1} ]}^{3} ) & [ Eq . 7 ]\end{matrix}$$

Swartz (1995) reported comparison tests of nickel, aluminum and iron cathodes with nickel, iron and platinum used as the anode in light water (H₂O) solutions under varying input power levels using the apparatus taught in the above-entitled application. The experiments examined the enthalpy generated by electrically driving each electrode pair, compared to ohmic controls within the same solution. The multi-ring calorimetric system with dual feedback control loops as shown in FIG. 3 was used to measure both the electrical power and energy delivered during each sequence, and compare them to that released by either, or both, the ohmic and electrolytic power sources. For controls, the ohmic resistors (as thermal heaters) are included with each experiment using metachronous bracketing of the reactor pulses [FIGS. 4 and 5]. Neither the iron nor aluminum as cathodes had any evidence of excess heat, but instead demonstrated recovered power ratios of only 0.71+/−0.1 and 0.75+/−0.1, respectively. Platinum, examined in the presence of nickel, did not show any compelling evidence of power gain either. The platinum anode-platinum cathode system, with the nickel electrode open circuited between the platinum electrodes, had recovered power ratios differing from 1.0 by levels comparable to noise at the low input electrical power levels tested [1.19+/−0.37].

With nickel, under controlled low to moderate current density conditions, excess heat is observed for several anode configurations (Table 3). Following minimization of the background noise, this thermal spectroscopy ruled out false indications of “excess heat” allowing focusing upon certain samples of nickel under controlled low to moderate current density conditions. For those samples, excess heat is observed for some anode configurations. For nickel wire as the anode and nickel wire as the anode, there is power amplification [π_{Ni}] in the range of 1.44+/−0.58 if the transsample potential (V_{cell}) is below 5 volts. Significant nickel colloid is formed which is of concern and contamination level. The rest of the experiments involved only platinum as the anode. There was more excess heat and significantly cleaner post-reaction reactors (measured by the absence of both corrosion and colloid products) in platinum anode reactor systems where cathodes were not driven as anodes. The power output is very dependent upon the area of the platinum. For nickel spiral cathodes with platinum foil anodes the power amplification is in the range of 2.27+/−1.02 for transsample potentials less than 5 volts. Peak power outputs have been in excess of 2 watts, with power densities (nickel) of more than 7+/−4.3 watts/cm³. For active samples, the peak energy ratios (Eₒᵤₜ/Eᵢₙ) were in the range of 1.3-1.9 (maximum 2.4). For example in FIGS. 4, 5, 6 and 7 it can be seen that the experimental data shown (experimental sequences 34-5, 33-7, and 34-3) are characterized by excess heats in greater amounts than that which occurred for the ohmic controls.

The noise of the system is comparable to the outputs at the lowest achievable controllable input electrical power levels. There are thus significant signal to noise problems at the lowest power inputs (0.1 microwatts to <˜1 milliwatts), and moderate problems in the range to: 5 milliwatts. The highest recorded power ratios (π_{Ni}=Pout/Pin) approached 5 to 7 or more but the increasing error bars at those small energies make these levels doubtful. An example of such increase is shown in FIG. 7. When platinum foil is used, at intermediate power inputs, the width of the error bars increase as the input power is decreased but net so much as to hide a clear excess heat for certain specific conditions characteristic of the material under examination.

The low noise multi-ring multiply stabilized calorimeter, described in the above-entitled application, has detected an optimum notch in the excess heat-current density curve. This biphasic behavior, or fine structure, may characterize other excess enthalpic phenomena, and therefore electrical drive conditions outside of a putative “notch” region may have contributed to some of the “negative” reports concerning this effect. A nonuniform behavior [fine structure or biphasic structure] is observed to characterize the generation of excess heat from nickel using light water [FIG. 7, Swartz (1995)]. Under those conditions where stability and sensitivity of the multi-ring calorimeter are maximized, an optimum “notch” or peak is observed in the curve of power gain versus input power, current (FIG. 7), and voltage (FIGS. 5, and 6) under low current density conditions. At the notch, the peak power ratio [π_{Ni}(max) defined as Π_{Ni}] of 2.5 to 3 is typical with a falloff under increasing input power or current levels towards a ratio of 1. For a single platinum wire as the anode, the optimal notch may have been shifted to the left because very few instances of excess enthalpy of significance are observed, and only at low current density.

Several false positives are avoided by the invention described in the above-entitled application [further discussed in Swartz (1995)]. Increased thermal conductivity from water vapor above the system has a sign such that if it does occur, it will make the detected excess heats a lower limit. Recombination has been reported to levels of milliwatts but is not a problem here for several reasons. First, this is a closed system. Second, and most importantly, any error due to recombination is definitively ruled out by taking the input power as V*I, defined by Poynting's vector. Third, many of the excess power levels are more than an order of magnitude greater than those provided by recombination. Fourth, if any recombination had not occurred, the measured outputs would also be a lower limit.

Silicate deposition has been hypothesized to create a false positive of “excess heat”, however elementary analysis reveals that it can provide heat but not excess heat under normal conditions, and furthermore silicates are not present here. The result of the electrical resistance effects by the leads is important, but in any case, could not account for the observed calibrated excess heat in these experiments using nickel. This is because the contacts and leads are measured for these experiments, and their resistances are arranged to be much less compared to the ohmic controls. They are explicitly included in the derivations as discussed below. Errors in power input calculations are significantly reduced by sampling at 1-10 Hertz, using precision current sources, and indicators when any rail voltage is reached.

The observations of biphasic behavior is consistent with some of the ‘negative’ experiments if such experiments were actually conducted in a region outside of the “notch”. Therefore such biphasic behavior of the materials may account for some of the wide-spread difficulties in observing the phenomena, because of driving the material at a π_{Ni} outside of the notch manifold. The biphasic nature, and the fall-off with increasing power input, is also consistent with the quasi-one-dimensional (Q1D) model of isotope loading [Swartz (1992), Swartz (1993), Swartz (1994)] especially wherein λ_{Ni} (the loading ratio) decreases with increasing power input [Swartz (1995)]. The Q1D model of isotopic loading has offered insight into both competitive gas-evolving reactions at the surfaces of the electrode and the impact of the ratio of the applied electric field energy to thermal energy [k_{B}*T]. The latter ratio is decisive in controlling the loading in palladium, and may be applicable to nickel and the proton reactions (or deuteron) at a nickel surface or in its volume. For nickel there is reason to believe that this may be a surface-local effect on the 110 surface.

In summary, the present invention includes a novel holding apparatus for said sample of material with a surrounding structure means to examine and load said sample. Said apparatus also includes means to irradiate said sample of material during loading and means to assess the activity of said sample. In one configuration said means of examining the activity of said sample of material consists of a multiring calorimeter with means to minimize the thermal noise during said examination, means including a series of concentric chambers surrounding the centrally placed sample of material. Said means to examine said sample also includes means to detect changes in the volume of said sample during electrolysis or gas loading with said fuel, means to compare the activity of said sample of said material with other substances, means to semiquantitatively determine the activity of said sample of said material by determining the generated power and energy secondary to said loading, and comparing that to the input power and energy to obtain the ratios of the instantaneous power (P_{OUT}/P_{IN}) and the cumulative energy (Eₒᵤₜ/Eᵢₙ). Additional means include multiprocessor computation and second and third order corrections to the measured powers and energies using differential and integral temperature signals. Said means to examine said material also includes integration of accumulated data for determining the optimum electrical drive condition for said sample of material.

The original specification, accompanied by the figures of said specification, clarify and define these matters to one skilled in the art by providing a complete description.

Modification of the invention herein disclosed will occur to persons skilled in the art and all such modifications are deemed to be within the scope of the invention as defined by the appended claims.

TABLE 2
TABLE OF SYMBOLS

| | | |
|---|---|---|
| A | area | cm² |
| α₁ | increased thermal capacity in | joules/(K-mole) |
| | first ring due to electrodes, | |
| | etc. | |
| B_{D} | diffusivity | cm²/sec |
| C_{P,H2O} | specific heat water | joules/(K-mole) |
| Δθ = T₁ − T₂ = | degrees K | Pₕ |
| delta-T | | |
| Δt | increment in time | seconds |
| ΔT | change in T during Δt | degrees K |
| [D]ᵢ | initial deuteron concentration | moles/cm³ |
| [D] | deuteron concentration | moles/cm³ |
| ΔF⁰(H₂O) | standard free enthalpy | joules |
| | water | |
| ΔG⁰(H₂O) | standard free energy water | joules |
| ∈ | electric field intensity | volts/meter |
| E | Energy | joules |
| Eₒᵤₜ − Eᵢₙ | Incremental Energy | joules |
| Eₒᵤₜ/Eᵢₙ | Relative Energy gain | nondimensional |
| Φ | the potential | volts |
| F | the Faraday | 96484.56 |
| | | coulombs/mole |
| γ₁₂ | thermal capacity of barrier | joules/(K-mole) |
| | between rings 1 & 2 | |
| I | electrical current | ampere |
| Jₑ | deuterons entering cathode | moles/cm²-sec |
| J_{g} | deuterons evolving to gas | moles/cm²-sec |
| J_{f} | deuterons in fusion reactions | moles/cm²-sec |
| k_{C} | thermal conductive coef. | joules/(cm²secK) |
| k_{R} | radiative conductive coef. | joules/(cm²secK⁴) |
| k_{B} | Boltzmann constant | joules/K |
| L | length | cm |
| L_{H2O} | enthalpy of evaporation for | joules/mole |
| | water | |
| L_{H2O} | enthalpy of evaporation for water | joules/mole |
| λ_{Ni} | loading ratio | nondimensional |
| μ_{D} | electrophoretic mobility | cm²/volt-sec |
| M_{Z12} | mass of barrier between rings 1,2 | grams |
| heater power | watts | |
| Pₓ | excess enthalpy = P excess | watts |
| P_{H2O} | partial pressure of water | torr |
| Π_{Ni} | power amplification factor | nondimensional |
| P_{electrolysis} | ohmic control heat | watts |
| P_{ambient} | ambient partial pressure | torr |
| Pᵢₙ | input power (= V * I) | watts |
| Pₒᵤₜ − Pᵢₙ | Incremental Power | watts |
| Pₒᵤₜ/Pᵢₙ | Power Amplification | nondimensional |
| | θ = used in calorimetry equations for | K |
| | temperature | |
| q | electric charge | coulombs |
| Θ_{λ, Ni} | Loading Potential Characteristic | 1/volts |
| σ_{SB} | Stefan-Boltzmann constant | joules/(cm²secK⁴) |
| T | temperature | degrees K |
| T₂ | temperature second ring | degrees K |
| T₁ | absolute temperature inner ring | degrees K |
| u₋₁(t) | Heaviside function | nondimensional |
| v | the potential | volts |
| V_{cell} | potential across electrochemical cell | volts |
| Vₜₕₑᵣₘₒₙₑᵤₜᵣₐₗ | thermoneutral potential | 1.48 volts |
| Y₁₂ | combined thermal coeff | joules/(cm²secK) |
| | (conductive and linearized radiative) | |
| Ψ_{fus} | deuterons involved | nondimensional |
| ζ | electrical order/thermal disorder ratio | nondimensional |

TABLE 1
COMPONENTS AND BARRIERS OF MULTI-RING CALORIMETER

| | | | | | | | | | | Stain- |
|---|---|---|---|---|---|---|---|---|---|---|
| | | | | | | pump | Poly- | | | Less |
| Location | Source | H₂O | Acrylic | Foam | H₂O | motor | Propylene | Aluminum | H₂O | Steel |
| RING | FIRST | | | | SECOND | | | | THIRD | |
| | INNER | | | | | | | | | |
| Closed | yes(**) | | | | | | | no | | |
| Compartment | C₁ | C₁ | B₁ | B₁ | C₂ | | B₂ | B₂ | C₃ | B₃ |
| or Barrier | | | | | | | | | | |
| Temp | | T₁ | | | T₂ | | | | T₃ | |
| Volume | | 4-80 | | | 600-1800 | | | | 1200-3800 | |
| (ml) | | | | | | | | | | |
| Thickness | 0.5 | 25* | 1.5 | 1-4** | 60 | | 1-1.5 | ** | 16 | 1.6 |
| (mm) | | | | | | | | | | |
| Feedback | | | | | | | | | | |
| +/− degree K | | <.1 | | | 0.1 | | | | .2 | |

| | | | Peltier | | | | Wood | |
|---|---|---|---|---|---|---|---|---|
| Location | Foam | Air Gap | Heater | ABS | Foam | ABS | Foam | Air |
| RING | | FOURTH | | | | | | FIFTH |
| Closed | no | | | | | | | |
| Compartment | | C₄ | | B₄ | B₄ | B₄ | B₄ | |
| or Barrier | | | | | | | | |
| Temp | | T₄ | | | | | | T₅ |
| Volume | | | | | | | | |
| (ml) | | | | | | | | |
| Thickness | 0.5-2** | * | | 8 | 28 | 8 | 20-120* ** | |
| (mm) | | | | | | | | |
| Feedback | | | Yes | | | | | Yes |
| +/− degree K | | .41 | | | | | | 2.5 |

*anisotropic
**variable

TABLE 2
VARIABLES

| | | |
|---|---|---|
| A | area | cm² |
| α₁ | increased thermal capacity in | joules/(K-mole) |
| | first ring due to electrodes, | |
| B_{D} | etc. diffusivity | cm²/sec |
| C_{P,H2O} | specific heat water | joules/(K-mole) |
| Δθ = T₁ − T₂ = | | degrees K |
| delta-T | | |
| Δt | increment in time | seconds |
| ΔT | change in T during Δt | degrees K |
| [D]ᵢ | initial deuteron concentration | moles/cm³ |
| [D] | deuteron concentration | moles/cm³ |
| ΔF⁰(H₂O) | standard | joules |
| | free enthalpy water | |
| ΔG⁰(H₂O) | standard | joules |
| | free energy water | |
| ∈ | electric field intensity | volts/meter |
| E | Energy | joules |
| Eₒᵤₜ − Eᵢₙ | Incremental Energy | joules |
| Eₒᵤₜ/Eᵢₙ | Relative Energy gain | nondimensional |
| Φ | the potential | volts |
| F | the Faraday | 96484.56 |
| | | coulombs/mole |
| γ₁₂ | thermal capacity of barrier | joules/(K-mole) |
| | between rings 1 & 2 | |
| I | electrical current | ampere |
| Jₑ | deuterons entering cathode | moles/cm²-sec |
| J_{g} | deuterons evolving to gas | moles/cm²-sec |
| J_{f} | deuterons in fusion reactions | moles/cm²-sec |
| k_{C} | thermal conductive coef. | joules/(cm²secK) |
| k_{R} | radiative conductive coef. | joules/(cm²secK⁴) |
| k_{B} | Boltzmann constant | joules/K |
| L | length | cm |
| L_{H2O} | enthalpy of evaporation for | joules/mole |
| | water | |
| L_{H2O} | enthalpy of evaporation for water | joules/mole |
| λ_{Ni} | loading ratio | nondimensional |
| μ_{D} | electrophoretic mobility | cm²/volt-sec |
| M_{Z12} | mass of barrier between rings 1,2 | grams |
| Pₕ | heater power | watts |
| Pₓ | excess enthalpy = Pexcess | watts |
| P_{H2O} | partial pressure of water | torr |
| Π_{Ni} | power amplification factor | nondimensional |
| P_{electrolysis} | ohmic control heat | watts |
| P_{ambient} | ambient partial pressure | torr |
| Pᵢₙ | input power (= V * I) | watts |
| Pₒᵤₜ − Pᵢₙ | Incremental Power | watts |
| Pₒᵤₜ/Pᵢₙ | Power Amplification | nondimensional |
| | θ = used in calorimetry equations for | K |
| | temperature | |
| q | electric charge | coulombs |
| Θ_{λ, Ni} | Loading Potential Characteristic | 1/volts |
| σ_{SB} | Stefan-Boltzmann constant | joules/(cm²secK⁴) |
| T | temperature | degrees K |
| T₂ | temperature second ring | degrees K |
| T₁ | absolute temperature inner ring | degrees K |
| u₋₁(t) | Heaviside function | nondimensional |
| v | the potential | volts |
| V_{cell} | potential across electrochemical cell | volts |
| Vₜₕₑᵣₘₒₙₑᵤₜᵣₐₗ | thermoneutral potential | 1.48 volts |
| Y₁₂ | combined thermal coeff | joules/(cm²secK) |
| | (conductive and linearized radiative) | |
| Ψ_{fus} | deuterons involved | nondimensional |
| ζ | electrical order/thermal disorder ratio | nondimensional |

1. In a process for producing a product from a sample of metal which is loaded with an isotopic fuel using electrolysis, a method to determine the optimum electrical drive condition for said sample and thereby characterize said sample that comprises in combination
mounting said sample into a calorimeter containing more than two rings with barriers between said rings,
filling with liquid the volume between each said ring,
supplying said isotopic fuel for said loading into said material,
loading said isotopic fuel into said sample by means of a power supply and electrical circuit,
thermally monitoring said liquid in each said ring,
deriving the thermal response of said sample by computational means including accounting for the mass and temperature distribution of at least one barrier between said rings,
increasing through a series of at least three incremental steps the electric power drive conditions of said electrical circuit,
deriving for each said step data consisting of the thermal output relationship of said sample as function of said drive steps,
thereby deriving an optimum drive condition of said sample.

2. A method as in claim 1 wherein said characterization is the peak relative output at said optimum.

3. In a process for manufacturing a group of samples of a material into which are to be loaded an isotopic fuel used to produce a product, a method to determine the optimum input electrical drive condition for each said sample so as to characterize each said sample taken from said group that comprises in combination;
separating said sample from a collection of samples obtained from sample fabrication equipment,
supplying said isotopic fuel for said loading into said material,
loading said isotopic fuel into said material by means of a power supply and electrical circuit,
monitoring said sample of material into which said isotopic fuel is loaded,
varying the electric power drive conditions of said electrical circuit,
deriving an output relationship of said product from said material as function of said drive conditions,
assembling said data in relationship to said drive condition,
thereby deriving an optimum drive condition of each said sample, and
sorting said group of samples with respect to said sample characterization.

4. A method as in claim 3 wherein said characterization includes the peak relative output of said sample.

5. A method as in claim 3, wherein said monitoring means examining the enthalpic activity of said sample of material.

6. A method as in claim 5, wherein said monitoring means of examining the enthalpic activity includes a series of concentric chambers and associated barriers surrounding the centrally placed sample of material as a series of rings.

7. A method as in claim 6, wherein said concentric chambers include at least one feedback loop to control temperature.

8. A method as in claim 3, wherein said monitoring means includes correcting for the mass of the barriers between said concentric chambers.

9. A method as in claim 3, wherein the first said barrier includes a relatively large thermal effective conductance between the first two chambers compared with outer rings means to produce a short experimental time constant.

10. A method as in claim 3, wherein said monitoring means includes microprocessor computation.

11. A method as in claim 3, wherein said derivation includes second and third order corrections to the measured powers and energies using integral temperature signals comprising to the terms involving both sides of each said barriers.

12. A method as in claim 3, wherein said computation includes means to perform calculations including enthalpic increases in each ring calculated using a quasi-1-dimensional model of adiabatic calorimetry with consideration of several compartments and barriers, calculations which are repeated for each ring with consideration of the different barriers and volumes.

13. A method as in claim 3, wherein said calibration includes thermal waveform reconstruction produced by thermal calibration sources.

14. A method as in claim 3, wherein said characterizing means includes calibration including members of the group utilizing a pulsing intermittent ohmic control for calibration, use of an additional sample of a material which does not load with said isotopic fuel.

15. In a process for producing a product from a sample of a material which is loaded with an isotopic fuel, a method to maximize the quantity produced of said product by said sample that comprises in combination;
loading said sample with said isotopic fuel by driving said sample as a cathode in combination with an anode and an electrical power supply,
monitoring said product obtained from said sample of material,
varying the input electrical drive conditions,
integrating the accumulated data to determine the optimum electrical drive condition for said sample of material,
characterizing said sample by the peak relative output of said product at said optimum, and
driving said sample at said optimum input electrical drive condition.

16. A method as in claim 15, wherein said material is a member of the group consisting of palladium, titanium, and nickel, and niobium.

17. A method as in claim 15, wherein said isotopic fuel is a member of the group consisting of protium and deuterium.

18. A method as in claim 15, wherein said loading occurs from a system which is a member of the group consisting of electrolysis loading and gas loading.

19. A method as in claim 15, which incorporates the additional step of maximizing the area of the anode relative to the cathode.

20. A method as in claim 1 wherein said metal is a member of the group consisting of palladium, titanium, and nickel, and niobium.
